(19) United States
(12) Patent Application Publication
(10) Pub. No.: US 2002/0098859 A1
(43) Pub. Date: Jul. 25, 2002

(54) Wireless communication terminal for sending messages for reporting power turn-off events

(75) Inventor: Masakazu Murata, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 10/052,558

(22) Filed: Jan. 23, 2002

(30) Foreign Application Priority Data
Jan. 24, 2001 (JP) 2001-015169

(51) Int. Cl. H04B 7/00

(52) U.S. Cl. 455/522; 455/572; 455/574

(57) ABSTRACT

A wireless communication terminal has an air interface for interfacing the terminal to a base station, an internal power source and an external power source. A power control circuit normally energizes the wireless communication terminal with the external power source and energizes the terminal with the internal power source when the external power source is faulty. A monitor circuit is provided for monitoring the external power source and sending a message from the air interface to a base station controller via the base station when the communication terminal is operating with the internal power source.

### BACKGROUND OF THE INVENTION

1. Field of the Invention

The present invention relates generally to wireless communication networks, and more specifically to a power monitoring and reporting technique for a fixed wireless communication network where wireless user terminals are normally energized with an external power source such as the mains (commercial) power supply and energized with an internal battery when the external power fails.

2. Description of the Related Art

Wireless communication systems such as FWA (fixed wireless access) have been developed as a means for establishing broadband user access channels between subscriber terminals and a communication network with an initial cost lower than the cost of laying wires and cables. The subscriber terminal is located in the user's premises and is energized by an external power source such as the mains supply. An internal battery is provided as a backup power source to be used when the external power source fails. If the battery voltage falls below some critical value, the battery power is turned off to prevent it from being excessively discharged. The failure in the external power source may be caused by power outage of the mains supply or by an inadvertent disconnection of the power line cord from the power outlet to the user terminal. When the user terminal is not working, the user is likely to place a complaint call to the network about the malfunctioning of his terminal, requesting a maintenance personnel to be dispatched to the user's premises for repairing the trouble. Since the network has no way of knowing the cause of the trouble, it has been necessary to make a trip to the premises of the complaining user.

Therefore, there exists a need to allow the maintenance personnel to identify the cause of a trouble in order to make it unnecessary for making a trip to the user terminal if the power source is identified as a probable cause of the trouble.

### SUMMARY OF THE INVETION

It is therefore an object of the present invention is to eliminate the need for a network maintenance personnel to make a trip to the site of a trouble for a possible cause of external power source.

According to a first aspect of the present invention, there is provided a wireless communication terminal comprising wireless communication circuitry for establishing a wireless communication channel to a network, an internal power source and an external power source, control circuitry for energizing the wireless communication terminal with the external power source and energizing the wireless communication terminal with the internal power source when the external power source is faulty, and monitor circuitry for monitoring the external power source and sending a message from the wireless communication circuitry to the network when the communication terminal is operating with the internal power source.

According to a second aspect, the present invention provides a wireless communication network comprising a base station, a base station controller connected to the base station, and a wireless communication terminal. The wireless communication terminal comprises wireless communication circuitry for interfacing the wireless communication terminal to the base station, an internal power source and an external power source, control circuitry for energizing the wireless communication terminal with the external power source and energizing the wireless communication terminal with the internal power source when the external power source is faulty, and monitor circuitry for monitoring the external power source and sending a message from the wireless communication circuitry to the base station controller via the base station when the communication terminal is operating with the internal power source.

According to a third aspect, the present invention provides a method of controlling a wireless communication terminal, wherein the terminal comprises wireless communication circuitry for interfacing the wireless communication terminal to a network, an internal power source and an external power source. The method comprises the steps of energizing the wireless communication terminal with the external power source and energizing the wireless communication terminal with the internal power source when the external power source is faulty, monitoring the external power source, and sending a message from the wireless communication circuitry to the network when the communication terminal is operating with the internal power source.

### BRIEF DESCRIPTION OF THE DRAWIGNS

The present invention will be described in detail further with reference to the following drawings, in which:

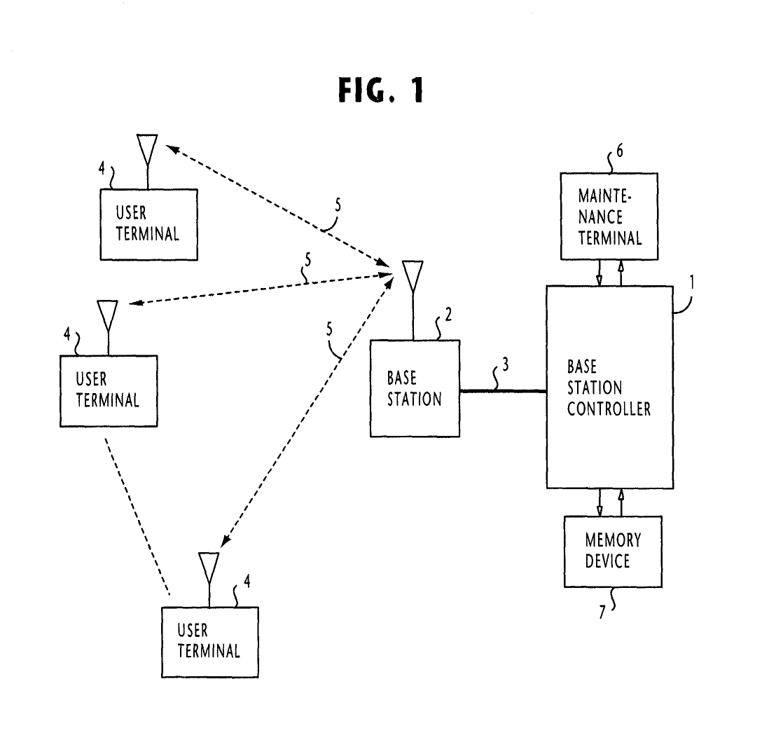

FIG. 1 is a block diagram of a fixed wireless access (FWA) communications network of the present invention;

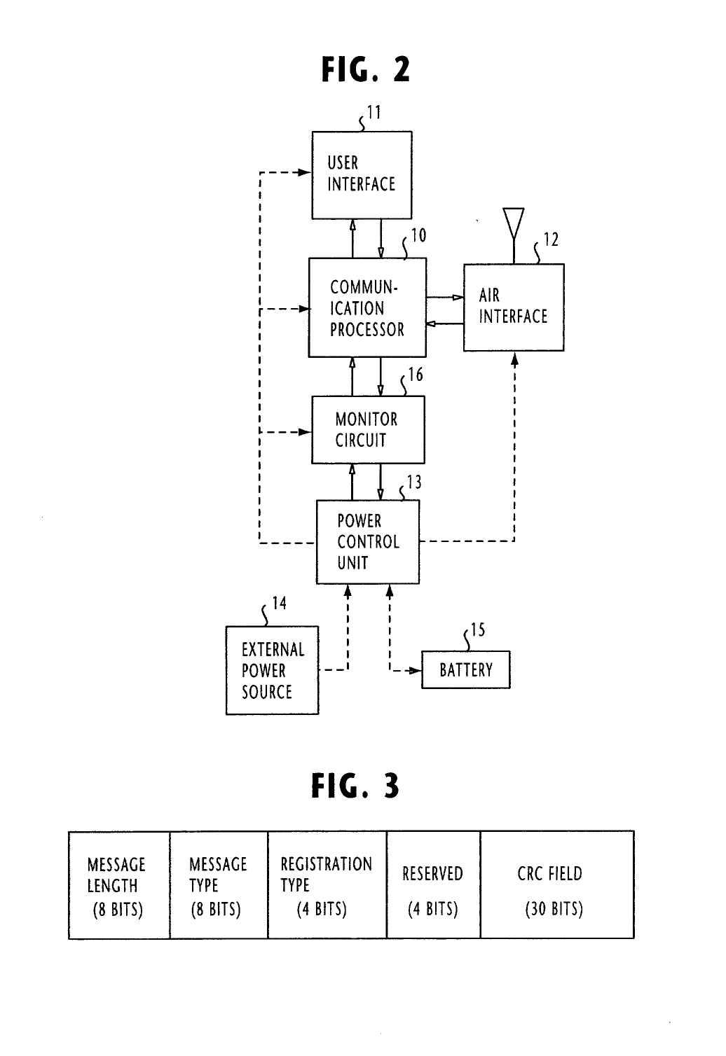

FIG. 2 is a block diagram of an FWA user terminal;

FIG. 3 shows the data structure of a location registration message sent from the user terminal; and

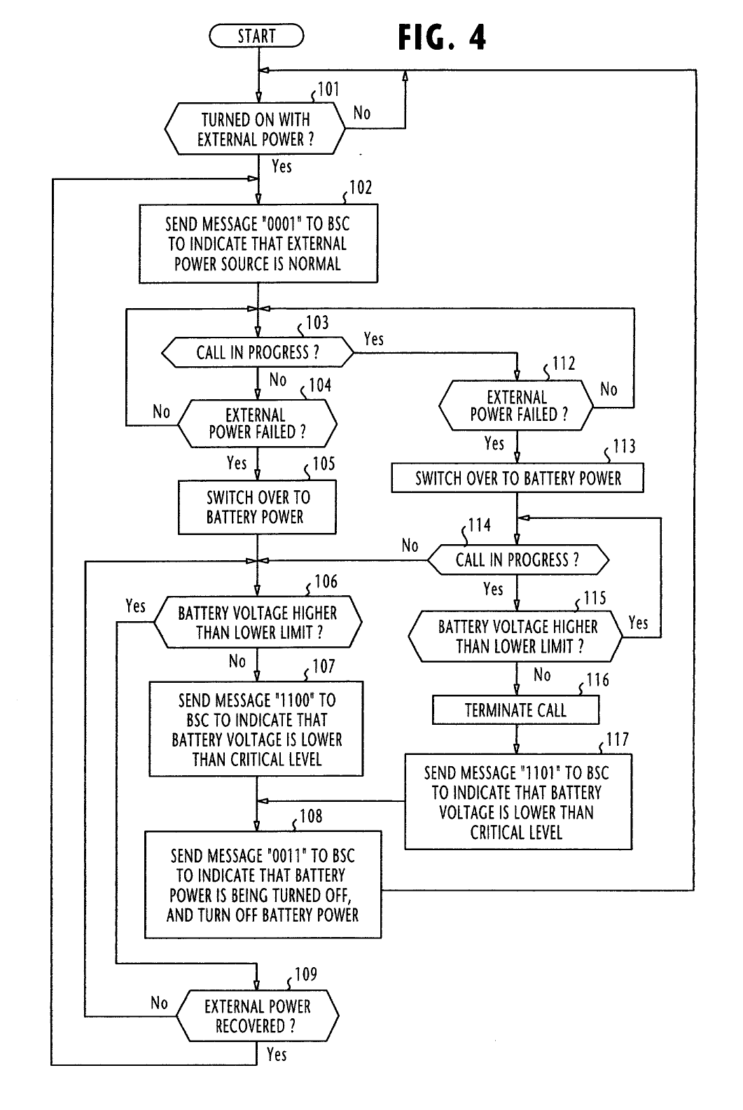

FIG. 4 is a flowchart of the operation of the network according to the present invention.

### DETAILED DESCRIPTION

Referring to FIG. 1, there is shown a fixed wireless access (FWA) communications network according to the present invention.

As illustrated, the network is comprised of a base station controller 1 which is connected via a communication link 3 to a plurality of wireless base stations. Base station controller 1 may be co-located with a switching system within the same switching office building or located in a maintenance center. For purposes of disclosure, only one wireless base station 2 is illustrated for individually serving user terminals 4 via fixed wireless access channels 5. A maintenance terminal 6 and a memory device 7 are connected to the base station controller 1. Data received from the user terminals 4 are stored in the memory device 7. Maintenance terminal 6 is attended to by the maintenance personnel of the network, who analyzes the data stored in the memory device 7.

As shown in FIG. 2, each user terminal 4 includes a communication processor 10 connected to a user interface 11 and an air interface 12. Air interface 12 establishes a CDMA (Code Division Multiple Access) channel to the base station 2 according to the ANSI/(American National Standard Institute)/TIA (Telecommunications Industry Association)/EIA (Electronic Industries Alliance)-95B. As a primary power voltage, an external power source 14 such as the commercial a.c. power is connected to the power control unit 13, which rectifies the a.c. voltage and supplies a constant d.c. voltage to the communication processor 10 and the air interface 11. An internal rechargeable battery 15 is also connected to the power control unit 13 as a backup power source when the external power should fail. When the external power source is normal, the rechargeable battery 15 may be trickle-charged by the power control unit 13. The user terminal normally operates on the external power source 14. If the external power should fail, the user terminal is switched to the internal battery 15 for continued operation. A monitor circuit 16 is provided to monitor the communication processor 10 and the power control unit 13 and sends a report message to the base station controller 1 via the base station 2 as to a state of the varying power condition of the user terminal. The report message received by the base station controller is stored in the memory device 7 and a collection of such messages are analyzed by the maintenance terminal 6.

For centralized management of report messages, it is advantageous to use the format of the ANSI/TIA/EIA-95B location registration message which is defined as an interface between the FWA subscribers and the serving base station. As shown in FIG. 3, the ANSI/TIA/EIA-95B location registration message has a number of fields for setting an 8-bit message length, an 8-bit message type, and an 8-bit message field which is divided into a 4-bit registration type sub-field and a 4-bit reserve sub-field. The message is terminated by a 30-bit cyclic redundant check field. In the present invention, the four-bit registration type sub-field is used to transmit report messages.

The operation of the monitor circuit 16 of each user terminal proceeds according to a flowchart shown in FIG. 4.

Initially, the monitor circuit 16 checks the power control circuit 13 to see if the user terminal is supplied with the external power (step 101). If this is the case, the monitor circuit 16 proceeds to step 102 to formulate a report message and transmits it from the processor 10 to the base station controller to indicate that the user terminal is normally operating with external power. The registration type sub-field of this normal report message contains “0001”.

Monitor circuit 16 proceeds to decision step 103 to check the communication processor 10 and determines if a call is in progress. If the user terminal is not in communication with the base station, then the monitor circuit checks the external power source to see if it has failed or not (step 104). If the external power source is normal, steps 103 and 104 are repeated. If the external power source has failed, the decision at step 104 is affirmative and the monitor circuit 16 proceeds to step 105 to direct the power control unit 13 to switch over the user terminal to the internal battery 15.

Then, the monitor circuit 16 monitors the battery voltage to determine whether it is higher than a critical lower limit. If the battery voltage falls below the critical level, the decision at step 106 is negative and the monitor circuit 106 proceeds to step 107 to formulate a report message with the registration type sub-field set with “1100” bits and transmits it to the base station controller, indicating that the external power source of a user terminal becomes faulty when no call is in progress and its battery voltage has dropped below the critical level. Monitor circuit 16 proceeds to step 108 to direct the power control unit 13 to turn off the battery to prevent it from being excessively discharged, and returns to the starting point of the routine to check for possible recovery of the external power source.

If the battery voltage is higher than the critical lower limit, the decision at step 106 is affirmative and flow proceeds to step 109 to check to see if the external power source is recovered. If not, steps 107 and 109 are repeated. If the external power source is recovered, the monitor circuit exits step 109 and returns to step 102 to send a report message indicating that the external power has been recovered.

If the external power source is normal and the user terminal is in communication with the base station, the decision at step 103 is affirmative. In such instances, the monitor circuit proceeds from step 103 to step 112 to check to see if the external power source has failed. If this is the case, flow proceeds to step 113 to switch over the user terminal to the internal battery power and the status of the call is monitored (step 114). If the call has terminated, flow proceeds from step 114 to step 106. If the call is still in progress, the monitor circuit proceeds to step 115 to check to see if the battery voltage is higher than the lower limit.

If the battery voltage is higher than the lower limit, steps 114 and 115 are repeated. If the battery voltage falls below the critical level, the monitor circuit proceeds from step 115 to step 116 to direct the communication processor 10 to forcibly terminate the call and proceeds to step 117 to formulate a report message by setting its registration type sub-field with “1101” bits and transmit the message to the base station controller, indicating that the external power source of a user terminal becomes faulty during a call and the battery voltage has dropped below the critical level. Flow proceeds from step 117 to step 108 to formulate a report message by setting the registration type sub-field with “0011” bits (which indicates that the battery power is being turned off) and transmit the message to the base station controller and turn off the battery power. Flow returns to step 101.

Since report messages sent from the user terminals are stored in the memory device 7 at the base station controller, the maintenance personnel can identify the source of a trouble if a complaint call is received from a user. If such a report message has been received from a complaining user, the maintenance personnel is able to instruct the user to fix the trouble. In this way, the need to identify the trouble by making a trip to the user's premises can be eliminated.

In addition, the present invention allows maintenance personnel to distinguish between the power turn-off event that occurs when no call is in progress and the power turn-off event that occurs when a call is in progress. If the former occurs, the disconnection of the power line cord is likely the primary cause of the trouble and the internal battery may also be deteriorated due to frequent turn-off of the external power source. If the latter occurs frequently, it is likely that the power line cord is the cause of the trouble.

What is claimed is:

1. A wireless communication terminal comprising:
wireless communication circuitry for establishing a wireless communication channel to a network;
an internal power source and an external power source;
control circuitry for energizing the wireless communication terminal with said external power source and energizing the wireless communication terminal with said internal power source when said external power source is faulty; and
monitor circuitry for monitoring said external power source and sending a message from said wireless communication circuitry to said network when said communication terminal is operating with said internal power source.

2. The wireless communication terminal of claim 1, wherein said monitor circuitry transmits said message when no call is in progress and transmits a second message from said wireless communication circuitry to said network when said communication terminal is operating with said internal power source when a call is in progress.

3. The wireless communication terminal of claim 1, wherein said message indicates that the internal power source is producing a voltage which is lower than a critical level.

4. The wireless communication terminal of claim 2, wherein said second message indicates that the internal power source is producing a voltage which is lower than a critical level.

5. The wireless communication terminal of claim 2, wherein said wireless communication channel is a fixed wireless access (FWA) channel.

6. The wireless communication terminal of claim 5, wherein said messages are sent in a data format specified by ANSI/(American National Standard Institute)/TIA (Telecommunications Industry Association)/EIA (Electronic Industries Alliance)-95B standard.

7. A wireless communication network comprising:
a base station;
a base station controller connected to said base station;
a wireless communication terminal including:
wireless communication circuitry for establishing a wireless communication channel to said base station;
an internal power source and an external power source;
control circuitry for energizing the wireless communication terminal with said external power source and energizing the wireless communication terminal with said internal power source when said external power source is faulty; and
monitor circuitry for monitoring said external power source and sending a message from said wireless communication circuitry to said base station controller via said base station when said communication terminal is operating with said internal power source.

8. The wireless communication network of claim 7, wherein said monitor circuitry transmits said message when no call is in progress and transmits a second message from said wireless communication circuitry to said base station controller when said communication terminal is operating with said internal power source when a call is in progress.

9. The wireless communication network of claim 7, wherein said message indicates that the internal power source is producing a voltage which is lower than a critical level.

10. The wireless communication network of claim 8, wherein said second message indicates that the internal power source is producing a voltage which is lower than a critical level.

11. The wireless communication network of claim 8, wherein said wireless communication channel is a fixed wireless access (FWA) channel.

12. The wireless communication network of claim 11, wherein said message is sent in a data format specified by ANSI/(American National Standard Institute)/TA (Telecommunications Industry Association)/EIA (Electronic Industries Alliance)-95B standard.

13. A method of controlling a wireless communication terminal, wherein the terminal comprises a wireless communication circuitry for establishing a wireless communication channel to a network, an internal power source and an external power source, the method comprising the steps of:
a) energizing the wireless communication terminal with said external power source and energizing the wireless communication terminal with said internal power source when said external power source is faulty;
b) monitoring said external power source; and
c) sending a message from said wireless communication circuitry to said network when said communication terminal is operating with said internal power source.

14. The method of claim 13, wherein the step (c) includes the steps of sending said message when no call is in progress and sending a second message from said wireless communication circuitry to said network when said communication terminal is operating with said internal power source when a call is in progress.

15. The method of claim 13, wherein said message indicates that the internal power source is producing a voltage which is lower than a critical level.

16. The method of claim 14, wherein said second message indicates that the internal power source is producing a voltage which is lower than a critical level.

17. The method of claim 14, wherein said wireless communication channel is a fixed wireless access (FWA) channel.

18. The method of claim 17, wherein said messages are sent in a data format specified by ANSI/(American National Standard Institute)/TIA (Telecommunications Industry Association)/EIA (Electronic Industries Alliance)-95B standard.
